(19) United States
(12) Patent Application Publication
(10) Pub. No.: US 2026/0133871 A1
(43) Pub. Date: May 14, 2026

(54) INTELLIGENT OPEN TELEMETRY EXCEPTION PROCESSING AND REPORTING

(71) Applicant: Cisco Technology, Inc., San Jose, CA (US)

(72) Inventor: Walter Theodore HULICK, JR., Pearland, TX (US)

(21) Appl. No.: 19/191,332

(22) Filed: Apr. 28, 2025

Related U.S. Application Data
(60) Provisional application No. 63/718,369, filed on Nov. 8, 2024.

(51) Int. Cl. G06F 11/07; G06F 11/362

(52) U.S. Cl. CPC G06F 11/0793; G06F 11/0751; G06F 11/0766; G06F 11/3644

(57) ABSTRACT

According to one or more embodiments of the disclosure, intelligent Open Telemetry exception processing and reporting is provided. In one embodiment, an illustrative method herein comprises: instrumenting a base throwable class of an application; intercepting an exception during runtime of the application based on the exception calling a throwable constructor during the instrumenting; processing the exception to determine one or more features associated with the exception; determining a responsive action to the exception based on the one or more features; and executing the responsive action.

### RELATED APPLICATION

This application claims priority to U.S. Provisional Application No. 63/718,369, filed Nov. 8, 2024, entitled INTELLIGENT OPEN TELEMETRY EXCEPTION PROCESSING AND REPORTING, by Walter Theodore Hulick, Jr., the contents of which are incorporated herein by reference.

### TECHNICAL FIELD

The present disclosure relates generally to computer networks, and, more particularly, to intelligent Open Telemetry exception processing and reporting.

### BACKGROUND

Catching and accurately assessing and reporting exceptions (faults that occur in an application) with Open Telemetry only works if the programmer or automated instrumentation wraps the code with a “try/catch” and creates a handler to then attach it to the current span. It is possible that situations occur in which there is no active span (housekeeping code) which means there is no way to report it.

In addition, there are some exceptions that may get caught further down in the code that don't propagate all the way to the try/catch. Further, in some situations developers may want to have flexibility in what they want to report or not report based on the Exception type—this type of dynamic decision making does not exist in either application programming interface (API)/software development kit (SDK) or the Open Telemetry Agent auto instrumentation.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example observability intelligence platform;

FIG. 4 illustrates an example system overview for intelligent Open Telemetry exception processing;

FIG. 5 illustrates an example runtime exception interception flow;

FIG. 6 illustrates an example Open Telemetry exception policy evaluation logic;

FIG. 7 illustrates an example exception report card visualization;

FIG. 8 illustrates an example high-level flow diagram for intelligent Open Telemetry exception handling; and

FIG. 9 illustrates an example procedure for intelligent Open Telemetry exception processing and reporting.

### DESCRIPTION OF EXAMPLE EMBODIMENTS

### Overview

According to one or more embodiments of the disclosure, intelligent Open Telemetry exception processing and reporting is provided. In particular, the techniques herein provide a “foolproof” way of automatically guaranteeing that the OTEL “sees”, can assess, can decide what to report, when to report, and how to report faults or security issues (exceptions) that are occurring in the application runtime.

In particular, in one embodiment, an illustrative method herein comprises: instrumenting a base throwable class of an application; intercepting an exception during runtime of the application based on the exception calling a throwable constructor during the instrumenting; processing the exception to determine one or more features associated with the exception; determining a responsive action to the exception based on the one or more features; and executing the responsive action.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

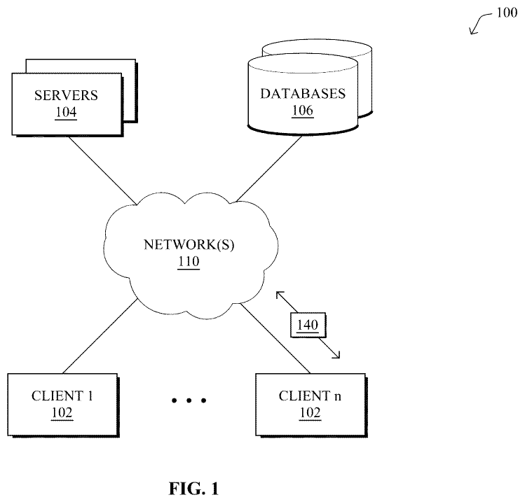

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

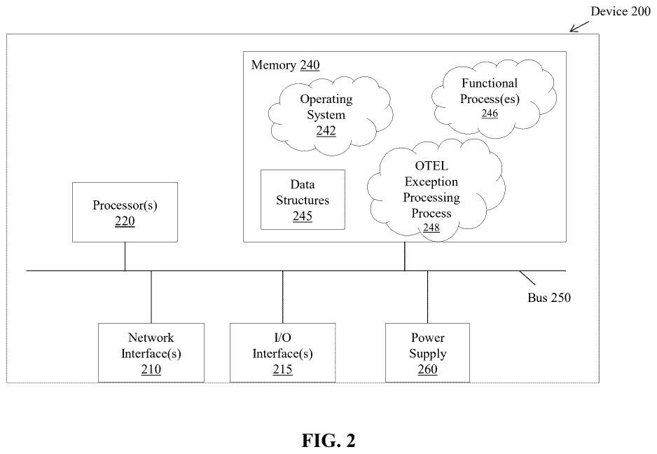

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an “OTEL exception processing” process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Observability Intelligence Platform

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more implementations herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

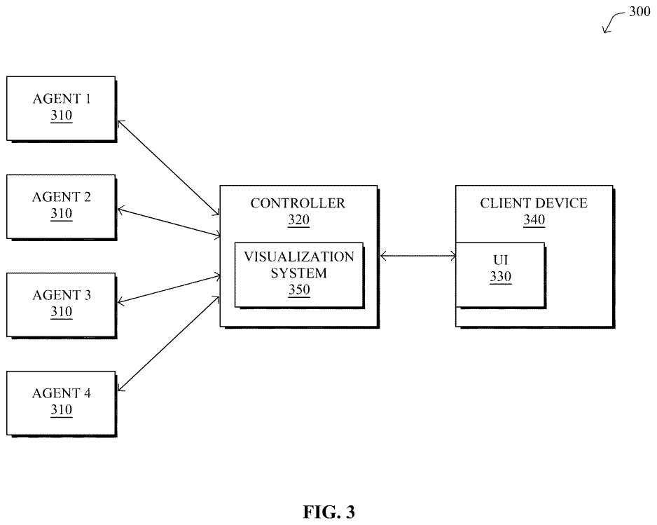

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable implementation of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (agents 310) and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) (interface 330) that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller instance may be installed locally and self-administered.

The controllers 320 receive data from different agents (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one implementation, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain implementations, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Furthermore, for reference, the following discussion is a brief primer on OpenTelemetry:
An “OpenTelemetry Trace” is defined as one or more OpenTelemetry Spans with all Spans sharing a common trace ID.
An “OpenTelemetry Span” is reported from a monitored application by an OpenTelemetry SDK or auto-instrumentation agent and includes:
   a) A pointer to the “parent” span, the span that captures what happened immediately before this one;
   b) A set of attributes: Key/Value pairs with information about the running program;
   c) A status: to indicate whether the application hit an error while processing this part of the request;
   d) A span kind: helps describe what action this span captures (call entering/leaving a service, internal to the service, etc.);
   e) A set of resource attributes: Key/Value pairs with information about where the span came from;
   f) A name to summarize the operation the span represents; and
   g) A start and end time.

An OpenTelemetry system thus creates and/or ingests batches of spans from various sources (agents and collectors) into a backend system such as that described above. Notably, spans may be grouped by trace IDs into trace messages, and the trace messages may be processed, starting at the root, and following all parent-child links.

Each span in the traversal is evaluated as a potential starting point for a business transaction. (Note that business transactions can be nested.) In particular, evaluation criteria this can be based off of may be as follows:
Name;
The position of the span in the trace;
Span kind;
Resource attributes;
Span attributes;
Etc.
   Furthermore, the rules that define conditions on these criteria can be defined by:
The system (“out of the box”/automatic rules);
Machine learning algorithms evaluating the ingested data;
A user (custom rules);
And so on.

Once any criteria is met, a Business Transaction (BT) Entity gets created. Metrics are then reported for the BT based on the status, start, and end time of the span that discovered it. All subsequent traversal of this trace will then report data in the “context” of this BT.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

### Intelligent Open Telemetry Exception Processing and Reporting

As noted above, catching and accurately assessing and reporting exceptions (faults that occur in an application) with Open Telemetry is a difficult task. Generally, it only works if the programmer or automated instrumentation wraps the code with a “try/catch” and creates a handler to then attach it to the current span. It is possible that situations occur in which there is no active span (housekeeping code) which means there is no way to report it. Additionally, there are some exceptions that may get caught further down in the code that don't propagate all the way to the try/catch. Further, in some situations developers may want to have flexibility in what they want to report or not report based on the Exception type—this type of dynamic decision making does not exist in either application programming interface (API)/software development kit (SDK) or the Open Telemetry Agent auto instrumentation.

The techniques herein provide for intelligent Open Telemetry exception processing and reporting. In particular, the techniques herein provide a “foolproof” way of automatically guaranteeing that the OTEL “sees”, can assess, can decide what to report, when to report, and how to report faults or security issues (exceptions) that are occurring in the application runtime.

As a reminder, Open Telemetry (or “OTEL”) generally refers to a collection of tools, application programming interfaces (APIs), and/or software development kits (SDKs). OTEL may be used to instrument, generate, collect, and/or export telemetry data (e.g., metrics, logs, and traces) that assist in analyzing the performance and behavior of a software system, as well as applications that are executed by the software system.

Notably, as will be understood by those skilled the art, an OTEL “span” is a data structure which represents a unit of work or an operation (e.g., within a transaction). Spans are the building blocks of traces, which are essential to understanding the full “path” a request takes in an application. Each Span is an observability-based data structure that encapsulates a number of states, such as an operation name, start and end timestamps, and a number of attributes (key-value pairs), among other fields (e.g., events, link, and so on).

In particular, as will be appreciated, a trace is generally a collection of parent/child spans, which are created during a transaction process. Each Span defines a “transition” in the trace (e.g., a web service call, web service entry, thread transition, etc.) process. Each span carries information about the span in “attributes,” as illustrated in the following pseudocode:
//Get current Span
Span span=Span.current( );
//Add custom attributes to Span
span.setAttribute(“SchoolName”, schoolname);

These attributes are eventually transmitted via a collector/exporter to a backend (e.g., backend receivers) via a wire protocol (e.g., via the Open Telemetry protocol (OTLP)—https://opentelemetry.io/docs/specs/otel/protocol/) and processed at the backend. That is, an Open Telemetry trace is made up as a series of spans—parent/child and they represent a flow and unit of work—each of which is eventually (if sampled) sent to a “collector” which exports them to a receiver to be recorded and eventually analyzed—and to then appear in a dashboard to visualize the trace.

Generally, current exception catching and reporting capabilities for OTEL are very primitive and non-standard. Also, they are only tied to tracing—so exceptions that occur outside of something being traced are not going to be reported. Existing exception reporting mechanisms (both attaching to a span) are based on a “recordException” method or an “addEvent” method.

For example, using the recordException method looks like the following:”

```
  Span span = myTracer.startSpan(/*...*/);
  try {
  // Code that does the actual work which the Span
represents
  } catch (Throwable e) {
  span.recordException(e,
Attributes.of(“exception.escaped”, true));
  throw e;
  } finally {
  span.end( );
  }
```

Using the addEvent method (which is encouraged over the recordException by some vendors) would look like the following (noting that an exception SHOULD be recorded as an Event on the span during which it occurred, and the name of the event MUST be “exception”):

```
  Span span = myTracer.startSpan(/*...*/);
  try {
  // Code that does the actual work which the Span
represents
  } catch (Throwable e) {
  span.recordException(e,
Attributes.of(“exception.escaped”, true));
  throw e;
  } finally {
  span.end( );
  }
```

This is inadequate for Open Telemetry because it requires attachment to an Active Span. When there is no span to attach to (there is a lot of code running outside of transactions which do not have a current span—this code is capable of generating Exceptions that may indicate problems in bootstrapping and/or other housekeeping operations).

Also, some exceptions occur and are caught before the span “try/catch” can see it. That is, there's often a good chance that the code being “wrapped” by this already has a try/catch. If it could generate an Exception, it would have to compile, in which case it would be caught and not trigger the “wrapped” try/catch so it would never be added to the Span itself.

Moreover, extra code is required to either manually or automatically add try/catch blocks or even to determine if it is needed. That is, instead of having to add try/catch blocks, it would be more efficient to simply have one block of code capable of detecting the Exception and reporting it.

Furthermore, exceptions are a key health indicator that should be processed accordingly. Today, in Open Telemetry, overall processing of exceptions is to simply take whatever is thrown and report it—it's either on or off, there is no intelligence.

There is currently no ability to determine the processing or reporting of an exception in real time based on an intelligent policy. Also, there are cases where you would want to be able to intelligently evaluate the exception, such as to determine the severity, collect additional information, escalate, determine the reporting “on the fly” in a centralized reporting area, all of which are not available in either the manual or automated instrumentation to date.

Operationally, the techniques herein thus provide an enhanced solution that is seamless and innovative for OTEL. In particular, the techniques herein provide an extension for the Open Telemetry Agent or automated instrumentation that would instrument the base throwable class and intercept exceptions (e.g., all exceptions) in the Java runtime.

In Java, all exceptions eventually call the throwable constructors. Once received, according to the techniques herein, the exception would be intelligently processed as follows:
The exception would be reviewed and classified by type and severity (e.g., type=“security”; severity=9 out of 10).
The exception stack would be reviewed and saved, and a “Checksum” attached uniquely identifying the call stack.
The type and severity would be evaluated against an OTEL Exception Policy File to determine:
   a) Whether it should be reported at all.
   b) A level of detail (e.g., 1: high, 2: medium, 3: low) of data to be collected to add to OTEL Signal Attributes.
   c) Whether there is an active span and not sampled (Note: There is instrumentation into the OSS OTEL Agent and/or use of the existing Tracer API/SDK that keeps a table via startSpan/endSpan to track the current active span for a Thread):
      If yes an active span exists that is not sampled—Then whether it should be reported by attaching to the Scan via the addEvent and/or recordException; or
      If no active span exists or it is sampled,—Then whether it should be reported by sending an OTEL Log Signal and/or Event Signal.
   d) Whether it should invoke a “circuit breaker” to minimize application disruption.
Overall Metrics would be collected and sent as an overall OTEL Metric Signal and contain a List of:
   a) type and security;
   b) instances/count;
   c) overall severity;
   d) first instance;
   e) last instance;
   f) avg per minute;
   g) overall Application severity impact;
   h) etc.

In addition to handling the Exceptions, this solution would/could actually “throw Exceptions” to be processed and may notify the OTEL backend processing receiver based on: serious security conditions; performance issues such as a “high latency trending”; and so on.

Additional considerations could be a rating system based on the Exception severity, frequency, etc. that could generate and visualize a health “Report Card”; a heat map, etc.

According to various embodiments herein, therefore, the current techniques allow for tracking of current spans via instrumentation, and exceptions are captured at a single instrumentation point versus having to instrument every method. Also, exceptions are seen even if they have been caught deeper in the code stack. Moreover, according to the techniques herein, the severity and type of the exception is assessed and intelligently reported/filtered/processed based thereon. Additionally, exceptions can be added to spans and sent as an Event, an Exception (if an active span exists), or sent via Log/Event signals simultaneously. Exception metrics are also generated herein that can be sent via the OTEL metrics signal. Exceptions may also be integrated into a “Tail Based” sampling algorithm via a span processor on the collector, accordingly. Moreover, the techniques herein provide for built-in circuit breaker capability at the processing point.

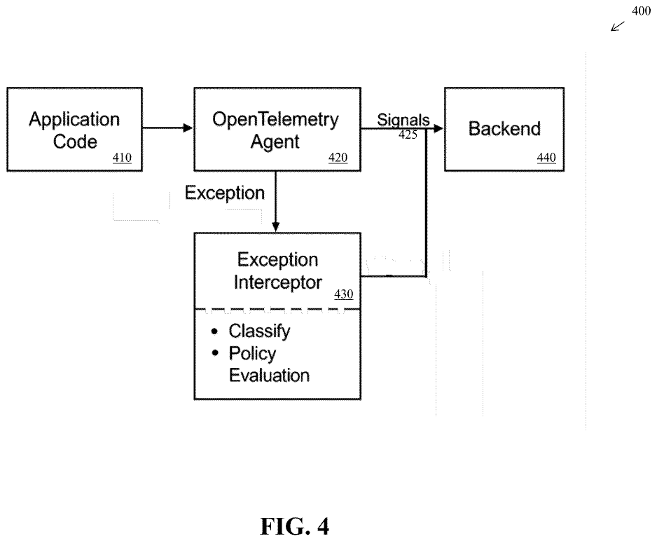

FIG. 4 illustrates an example architecture (architecture 400) for intelligent exception processing and reporting in an OpenTelemetry-enabled application. As shown, while application code 410 executes, the OpenTelemetry Agent 420 monitors the runtime activity of the associated host application to generate telemetry signals as described above. The OpenTelemetry Agent normally handles spans and generates signals 425 such as traces or metrics. When an exception occurs in the runtime, the Exception Interceptor 430 intercepts the throwable event, and performs classification and policy evaluation, determining how to generate the appropriate telemetry signals (e.g., trace, log, or metric), which are then sent to the backend 440 for analysis and visualization. That is, the Exception Interceptor classifies the exception by type and severity, evaluates it using an Exception Policy File, and determines the proper signal path: either attaching the exception to an existing span, generating a separate log or metric, or triggering a circuit breaker condition. Signals produced by this process are sent to the backend (e.g., directly to backend 440, or else returned via the OpenTelemetry Agent 420) for further processing, aggregation, and visualization. This architecture supports flexible decision making based on severity, active span status, and exception type, and allows for collection of telemetry regardless of whether exceptions were originally tied to a span.

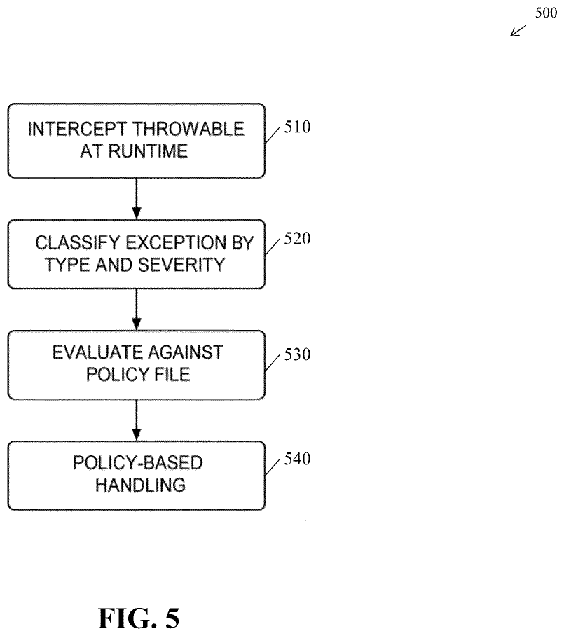

FIG. 5 illustrates a runtime exception interception flow (flow 500) showing the runtime exception interception and policy-handling process according to the techniques described herein. The process begins in step 510 with the interception of a Throwable at runtime (e.g., a Java Throwable), for example via constructor instrumentation in the OpenTelemetry Agent. Once intercepted, the exception is classified in step 520 in terms of its severity and type (e.g., security-related, performance, unexpected failure, etc.). This classified information is then evaluated against a Policy File, which contains decision rules governing exception handling behavior (i.e., exception-handling rules), in step 530. Based on this evaluation, in step 540 the system performs policy-based handling, which may include one or more policy-based actions such as emitting trace or log signals, escalating a response, collecting further metrics, suppressing low-impact exceptions, or circuit-breaking actions.

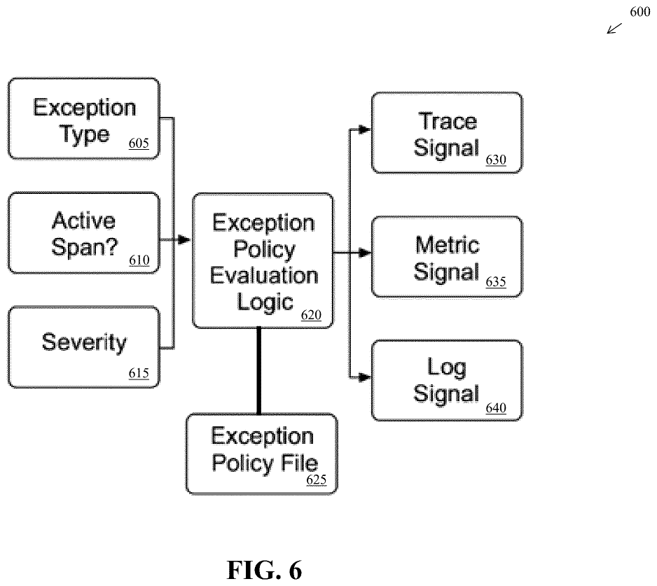

FIG. 6 illustrates an example of an OTEL Exception Policy Evaluation Logic (logic 600) used in determining how to process an intercepted exception in the OpenTelemetry system. The evaluation process uses multiple inputs, including an exception type 605, the status (presence or absence) of an active span (active span 610), and the severity of the exception (severity 615). These parameters are evaluated by an Exception Policy Evaluation Logic Engine (evaluation engine 620), which, illustratively based on a configured exception policy file (exception policy file 625), applies decision logic to determine the appropriate output signal. Depending on the result of the evaluation, the system may generate either a trace signal 630 (e.g., when a span is available), a metric signal 635 (e.g., for aggregated metrics), or a log signal 640 (e.g., when span context is absent or minimal detail is needed).

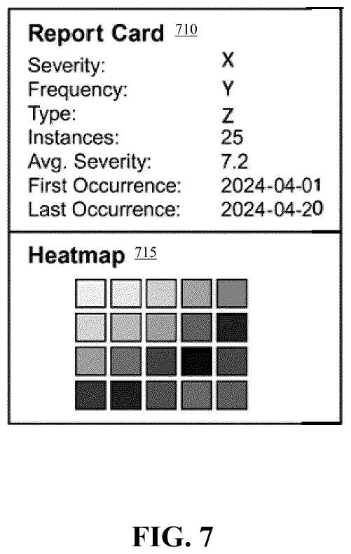

FIG. 7 illustrates a visualization framework (visualization 700) for exception monitoring and reporting. The example exception report card and heatmap visualization generated by the OpenTelemetry backend is based on the signals produced by the Exception Interceptor as described above, and the specific visualization shown is merely an example and is not meant to limit the scope of the present disclosure. The report card 710 may be generated for each exception classification or call stack signature, and assigns letter or numeric grades or other summarization (e.g., shown simply as “X”, “Y”, “Z”, etc.) to exception characteristics such as severity, frequency, and type. Report card 710 may also include other information such as counts (instances) and timestamps of exception instances (e.g., first occurrence and last occurrence), average severity, and so on. A heatmap 715 may be used to display relative exception density or severity across a given time range or set of monitored services, for example with darker cells or shades (depending on the designed user interface) indicating higher/denser activity or impact across time windows or system components. This visualization 700 enables operators and backend analytics systems to quickly identify trends, outliers, and root causes, as processed exception data can be visualized in an intuitive format for engineering and operations personnel to prioritize remediation.

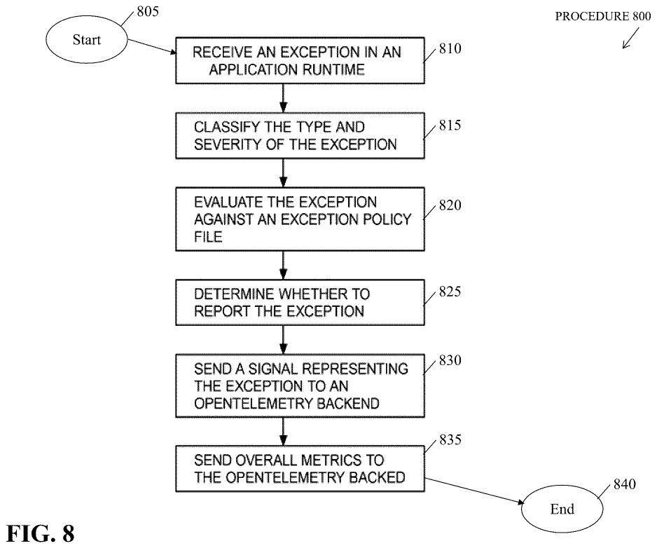

An example of the full system and lifecycle described herein in accordance with one or more embodiments herein can be conceptually summarized in FIG. 8, which presents a high-level process flow (procedure 800) for intelligent OpenTelemetry exception processing and reporting. For example, the procedure 800 may start at step 805, and continues to step 810, where, as described in greater detail above, where an exception or throwable is received (intercepted) during the runtime of a Java application. This interception occurs at the base Throwable level through instrumentation, ensuring that all exceptions (e.g., regardless of whether they are tied to a traceable span) can be observed.

In step 815, the exception may be classified by its type (e.g., security, performance, system failure, etc.) and severity (e.g., on a scale from 1 to 10). A unique checksum (e.g., hash) of the stack trace may also be generated for deduplication or correlation purposes. Simultaneously, the runtime system attempts to retrieve the currently active span context, if any, by referencing thread-based span tracking mechanisms within the OTEL agent or SDK.

The process continues at step 820, where the classified exception is evaluated against a configurable Exception Policy File. This file defines exception-handling rules including reporting thresholds (e.g., severity thresholds), escalation triggers and behavior, span requirements, and how much detail should be included for each type or severity of exception.

In step 825, the system determines whether and how to report the exception. This decision may include one or more of the following:
Attaching the exception to an active span using addEvent or recordException methods;
Emitting a standalone OTEL Log or Event signal if no active span exists or the span is not sampled;
Suppressing the exception from being reported if deemed low-priority by policy;
Aggregating and logging metrics related to the exception; and/or
Invoking a circuit breaker condition if the severity or frequency exceeds a defined threshold to help prevent broader application disruption.
   For example, if a span exists, the policy determines whether to attach the exception to the span using either addEvent or recordException. If no span is active or it has been sampled out, the exception may instead be reported via OTEL Logs or Event signals. The system consults a configurable Exception Policy File to determine how much detail to include, whether to escalate, and whether to trigger a circuit breaker. Aggregated metrics about exception occurrences may also be collected and sent via OTEL Metrics.

If the exception is to be reported, in step 830 the techniques herein send the selected signal(s) (e.g., trace, log, or event) to the OpenTelemetry backend (e.g., forwarding via an OTEL collector or receiver), using protocols such as OTLP. These signals may contain metadata from the policy evaluation as well as contextual attributes.

Optionally, step 835, the techniques herein may also send aggregated exception metrics (e.g., frequency, severity trends, system impact scores, etc.) to the backend for ongoing observability and visualization. These metrics may later feed into dashboards, heatmaps, or automated health scoring systems.

The example high-level process ends at step 840. Accordingly, the techniques herein, based on this process, thus ensure centralized, consistent, and dynamic exception handling regardless of whether exceptions occur inside traced application logic or outside traditional span contexts, such as in housekeeping or bootstrapping code.

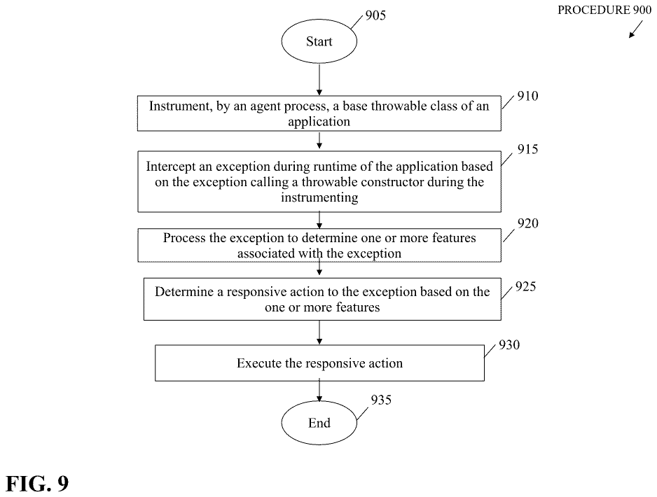

In closing, FIG. 9 illustrates another example simplified procedure for intelligent Open Telemetry exception processing and reporting in accordance with one or more embodiments described herein, particularly from the perspective of an agent process on a device or other similarly configured process on a device. For example, a non-generic, specifically configured device (e.g., device 200, an apparatus) may perform procedure 900 by executing stored instructions (e.g., process 248). The procedure 900 may start at step 905, and continues to step 910, where, as described in greater detail above, the agent process instruments a base throwable class of an application. (Note that the base throwable class of the application may be a sole instrumentation point for the application, where no methods need to be individually instrumented.)

In step 915, the techniques herein may then intercept an (e.g., any) exception (e.g., all exceptions) during runtime of the application based on the exception calling a throwable constructor during the instrumenting, as detailed above.

In step 920, the techniques herein may then process the exception to determine one or more “features” associated with the exception, such that in step 925, the techniques herein may then determine a responsive action to the exception based on the one or more features. As described above, the processing within step 920 may perform one or more of the following in order to determine corresponding features, accordingly:
classify the exception based on type, severity, or both type and severity (e.g., where the responsive action is based on these classified features);
retrieve a current span context associated with an executing thread of the application at a time of the exception (e.g., where the responsive action is based on the current span context, or lack thereof);
consult a policy to determine the responsive action (e.g., where the policy may define different levels of detail for telemetry signals);
compute a stack trace checksum for deduplication or severity analysis;
Etc.
   Furthermore, the responsive action in step 925 may be any one or more of the following, as described above:
reporting the exception (e.g., generating and transmitting a telemetry signal to a telemetry collector for further processing);
generating a telemetry signal containing contextual information for the exception in response to there being no current span context;
triggering a circuit breaker condition if the exception meets a predefined threshold related to the one or more features;
updating an exception report card visualization based on the one or more features;
suppressing exception reporting based on the one or more features;
And so on.

In step 930, the techniques herein may then execute the responsive action, accordingly. Procedure 900 may end at step 935.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In particular, in some implementations, an illustrative method herein may comprise: instrumenting, by an agent process, a base throwable class of an application; intercepting, by the agent process, an exception during runtime of the application based on the exception calling a throwable constructor during the instrumenting; processing, by the agent process, the exception to determine one or more features associated with the exception; determining, by the agent process, a responsive action to the exception based on the one or more features; and executing, by the agent process, the responsive action.

In one embodiment, processing comprises: classifying the exception based on type, severity, or both type and severity. In one embodiment, the responsive action is based on the classifying.

In one embodiment, processing comprises: retrieving a current span context associated with an executing thread of the application at a time of the exception. In one embodiment, the responsive action is based on the current span context. In one embodiment, the responsive action is based on there being no current span context. In one embodiment, the responsive action, in response to there being no current span context, comprises: generating a telemetry signal containing contextual information for the exception.

In one embodiment, processing comprises: consulting a policy to determine the responsive action. In one embodiment, the policy defines a plurality of levels of detail for telemetry signal payloads depending on the one or more features.

In one embodiment, the responsive action comprises a plurality of responsive actions.

In one embodiment, the responsive action comprises: reporting the exception. In one embodiment, reporting comprises: generating a telemetry signal; and transmitting the telemetry signal to a telemetry collector for further processing. In one embodiment, the telemetry signal comprises one or more of: a trace event, a log, or a metric.

In one embodiment, processing comprises: computing a stack trace checksum for deduplication or severity analysis.

In one embodiment, the responsive action comprises: triggering a circuit breaker condition if the exception meets a predefined threshold related to the one or more features.

In one embodiment, the responsive action comprises: updating an exception report card visualization based on the one or more features.

In one embodiment, the responsive action comprises: suppressing exception reporting based on the one or more features.

In one embodiment, the base throwable class of the application is a sole instrumentation point for the application.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: instrumenting a base throwable class of an application; intercepting an exception during runtime of the application based on the exception calling a throwable constructor during the instrumenting; processing the exception to determine one or more features associated with the exception; determining a responsive action to the exception based on the one or more features; and executing the responsive action.

In still other implementations, a tangible, non-transitory, computer-readable medium storing program instructions that cause a device to execute a process comprising: instrumenting a base throwable class of an application; intercepting an exception during runtime of the application based on the exception calling a throwable constructor during the instrumenting; processing the exception to determine one or more features associated with the exception; determining a responsive action to the exception based on the one or more features; and executing the responsive action.

The techniques described herein, therefore, provide for intelligent Open Telemetry exception processing and reporting. In particular, in Open Telemetry (OTEL), exception catching and reporting is still very primitive. That is, OTEL exception handling is currently generally lackluster in capability beyond carrying an exception within a span/trace as a flagged event. The techniques herein, however, provide enhanced capabilities to exception processing and reporting, as described in greater detail above. “Deep level” observability of exceptions (performance/security) teamed with a policy to process and visualize differentiate the techniques herein with every other OTEL solution in the market today.

Illustratively, the techniques described herein may be performed by hardware, software, and/or firmware, (e.g., an “apparatus”) such as in accordance with the OTEL exception processing process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

As used herein, the terms “application” and “applications” generally refer to a computer program or computer programs that are designed to carry out a specific task or tasks other than task(s) relating to the operation of the computer itself. In particular, an “application” can refer to a collection of executable computer code that is provided to, or is integrated into, a software system. As a result, the “application” or “applications” discussed herein can refer to any collection computer code that is executed by, or provided by, the software system.

By way of example, the applications mentioned herein can be host applications that run on various computing systems, such as a physical computer (e.g., a desktop, a laptop, a smartphone, a tablet, a phablet, etc.), a virtual computer (e.g., a thin client, a virtual machine, a Linux container, etc.), a data center (e.g., rack server, supercomputer, etc.), and/or a software defined data center (e.g., bare metal server), etc. Accordingly, the applications described herein can be locally provided host applications, virtually provided host applications, and so on and so forth.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
instrumenting, by an agent process, a base throwable class of an application;
intercepting, by the agent process, an exception during runtime of the application based on the exception calling a throwable constructor during instrumenting;
processing, by the agent process, the exception to determine one or more features associated with the exception;
determining, by the agent process, a responsive action to the exception based on the one or more features; and
executing, by the agent process, the responsive action.

2. The method as in claim 1, wherein processing comprises:
classifying the exception based on type, severity, or both type and severity.

3. The method as in claim 2, wherein the responsive action is based on classifying.

4. The method as in claim 1, wherein processing comprises:
retrieving a current span context associated with an executing thread of the application at a time of the exception.

5. The method as in claim 4, wherein the responsive action is based on the current span context.

6. The method as in claim 4, wherein the responsive action is based on there being no current span context.

7. The method as in claim 6, wherein the responsive action, in response to there being no current span context, comprises:
generating a telemetry signal containing contextual information for the exception.

8. The method as in claim 1, wherein processing comprises:
consulting a policy to determine the responsive action.

9. The method as in claim 8, wherein the policy defines a plurality of levels of detail for telemetry signal payloads depending on the one or more features.

10. The method as in claim 1, wherein the responsive action comprises a plurality of responsive actions.

11. The method as in claim 1, wherein the responsive action comprises:
reporting the exception.

12. The method as in claim 11, wherein reporting comprises:
generating a telemetry signal; and
transmitting the telemetry signal to a telemetry collector for further processing.

13. The method as in claim 12, wherein the telemetry signal comprises one or more of: a trace event, a log, or a metric.

14. The method as in claim 1, wherein processing comprises:
computing a stack trace checksum for deduplication or severity analysis.

15. The method as in claim 1, wherein the responsive action comprises:
triggering a circuit breaker condition if the exception meets a predefined threshold related to the one or more features.

16. The method as in claim 1, wherein the responsive action comprises:
updating an exception report card visualization based on the one or more features.

17. The method as in claim 1, wherein the responsive action comprises:
suppressing exception reporting based on the one or more features.

18. The method as in claim 1, wherein the base throwable class of the application is a sole instrumentation point for the application.

19. A tangible, non-transitory, computer-readable medium storing program instructions that cause a device to execute a process comprising:
instrumenting a base throwable class of an application;
intercepting an exception during runtime of the application based on the exception calling a throwable constructor during instrumenting;
processing the exception to determine one or more features associated with the exception;
determining a responsive action to the exception based on the one or more features; and
executing the responsive action.

20. An apparatus, comprising:
one or more network interfaces to communicate with a network;
a processor coupled to the one or more network interfaces and configured to execute one or more processes; and
a memory configured to store a process that is executable by the processor, the process comprising:
instrumenting a base throwable class of an application;
intercepting an exception during runtime of the application based on the exception calling a throwable constructor during instrumenting;
processing the exception to determine one or more features associated with the exception;
determining a responsive action to the exception based on the one or more features; and
executing the responsive action.
